(19) United States
(12) Patent Application Publication
(10) Pub. No.: US 2006/0156055 A1
(43) Pub. Date: Jul. 13, 2006

(54) Storage network that includes an arbiter for managing access to storage resources

(75) Inventors: Jacob Cherian, Austin, TX (US); Rohit Chawla, Waco, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/034,899

(22) Filed: Jan. 13, 2005

(51) Int. Cl. G06F 11/00

(52) U.S. Cl. 714/4

(57) ABSTRACT

A cluster network is disclosed that includes a set of nodes coupled to a storage enclosure. The storage enclosure includes an arbiter for managing contention for ownership of the storage drives of the storage enclosure. The arbiter receives ownership commands and arbitrates the ownership of the storage drives on the basis of the commands and the current ownership settings of the affected storage drives. The arbiter is coupled to the SAS expander or multiplexer in the storage enclosure that routes communications to each of the storage drives of the storage enclosure.

### TECHNICAL FIELD

The present disclosure relates generally to computer networks, and, more particularly to a storage network that includes an arbiter within a storage enclosure for managing control of the logical units of the storage enclosure.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

Computers, including servers and workstations, are often grouped in clusters to perform specific tasks. A server cluster is a group of independent servers that is managed as a single system. Compared with groupings of unmanaged servers, a server cluster is characterized by higher availability, manageability, and scalability. A server cluster typically involves the configuration of a group of servers such that the servers appear in the network as a single machine or unit. At a minimum, a server cluster includes two servers, which are sometimes referred to as nodes and which are connected to one another by a network or other communication links.

A cluster server architecture may involve a shared set of storage resources in which each server in the cluster may have simultaneous access to each shared storage resource. As an alternative, a cluster server architecture may be a shared-nothing architecture in which each server owns all or part of the shared storage resources. The storage resources owned by a server in the cluster are not accessible by other servers. In the event of a failure of a server, another server of the network can assume control over the storage resource.

The servers of the cluster server may communicate with the shared storage network and resources according to the Serial Attached SCSI (SAS) communications protocol. Serial Attached SCSI is a storage network interface that is characterized by a serial, point-to-point architecture. In addition, the storage of a cluster network may include some element of fault tolerant storage. One example of fault tolerant storage is RAID (Redundant Array of Independent Disks) storage. RAID storage involves the organization of multiple disks into an array of disks to obtain performance, capacity, and reliability advantages.

The storage recourses of the network may comprise one or more storage enclosures, which may house a plurality of disk-based hard drives. The servers of the cluster may use a SCSI RESERVE command to logically reserve or own logical units or drives of a storage enclosure of the storage network, such that no other server in the cluster can access it. The server may release control over any reserved logical units with a SCSI RELEASE command. A RESERVE and RELEASE command and ownership structure may not work well with RAID logical units in the absence of a shared external RAID controller in the storage network. The use of distributed RAID controllers that are internal to each server of the cluster necessitates that information concerning the ownership of drives of the storage enclosure be communicated to and synchronized with respect to each distributed RAID controller of the network. Using node-to-node communication links between distributed RAID controllers to establish and resolve ownership over logical units is complicated and expensive.

### SUMMARY

In accordance with the present disclosure, a cluster network is disclosed that includes a set of nodes coupled to a storage enclosure. The storage enclosure includes an arbiter for managing contention for ownership of the storage drives of the storage enclosure. The arbiter receives ownership commands and arbitrates the ownership of the storage drives on the basis of the commands and the current ownership settings of the affected storage drives. The command issued by the server node may be issued according to a first command language, which may be translated for handling by the arbiter. The arbiter is coupled to an SAS expander in the storage enclosure that routes communications to each of the storage drives of the storage enclosure.

The architecture and methodology disclosed herein is technically advantageous because the use of an arbiter associated with an SAS expander of a storage enclosure serves as an efficient and lower cost substitute for an external RAID controller in a cluster network. As a result, the ownership of the logical units of a storage enclosure can be managed using internal RAID controllers without communication between the distributed controllers on the servers in the cluster and without the necessity of using an external RAID controller in the network.

The architecture and methodology disclosed here is also advantageous because of the centralized management of storage resources. Each server node and associated RAID controller can manage ownership over the set storage drives of the storage enclosure without the involvement of and without reporting ownership information to the other server nodes and RAID controllers of the cluster network. The architecture and methodology disclosed herein is also advantageous because the architecture and methodology is not limited in it application to RAID storage methodologies that use the SCSI RESERVE-RELEASE protocol for reserving access to storage resources. The architecture and methodology disclosed herein can be used for any application where the ownership of a shared resource needs to be established and maintained. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a storage network;

FIG. 2A is a diagram of a logical ownership table reflecting the ownership of the logical units of the storage enclosure;

FIG. 2B is a diagram of a logical unit ownership table.

FIG. 3 is a diagram of a node of the storage network;

FIG. 4 is a flow diagram of a method for handling reservation commands issued by a node of the computer network; and

FIG. 5 is a flow diagram of a method for handling release commands issued by a node of the computer network.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

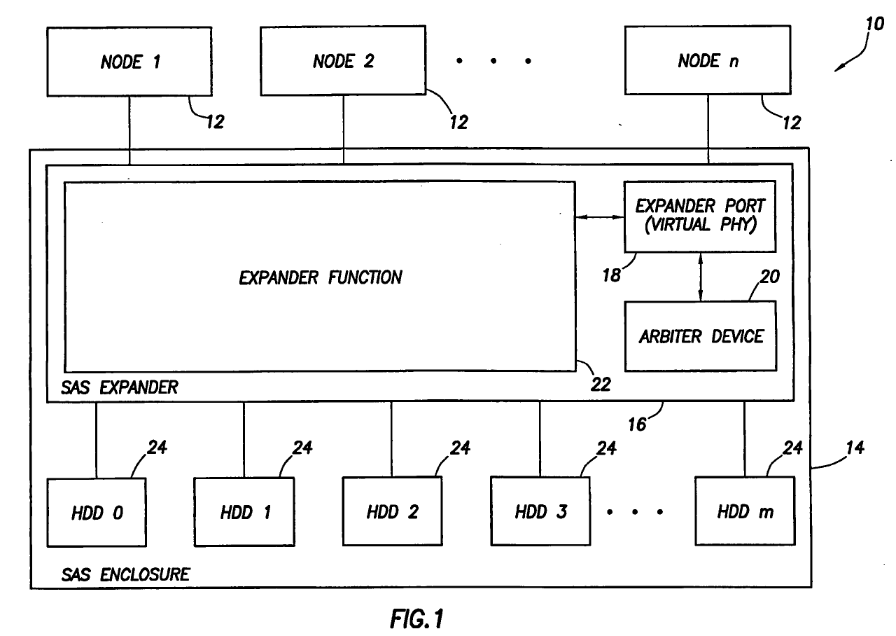

Shown in FIG. 1 is diagram of a storage network, which is indicated generally at 10. Storage network 10 includes a plurality of sever nodes 12 forming a server cluster. Each of server nodes 12 is coupled to a storage enclosure 14. Storage enclosure 14 includes an SAS expander 16, which is coupled to a plurality of drives 24. One or more of drives 24 may be configured as one or more logical units by the RAID controllers in the node. SAS expander 16 includes an expander port 18 coupled to each of the server nodes 12 and an arbiter device 20. Coupled to the expander port 18 is an expander core 22, which performs the function of expanding and routing signals from the nodes to each of the hard drives of the storage enclosure in accordance with existing protocols and specifications for SAS communications. Also included within SAS expander 16 is an arbiter 20. Arbiter 20 functions to manage the ownership of the logical units of the storage enclosure by the nodes of the storage network.

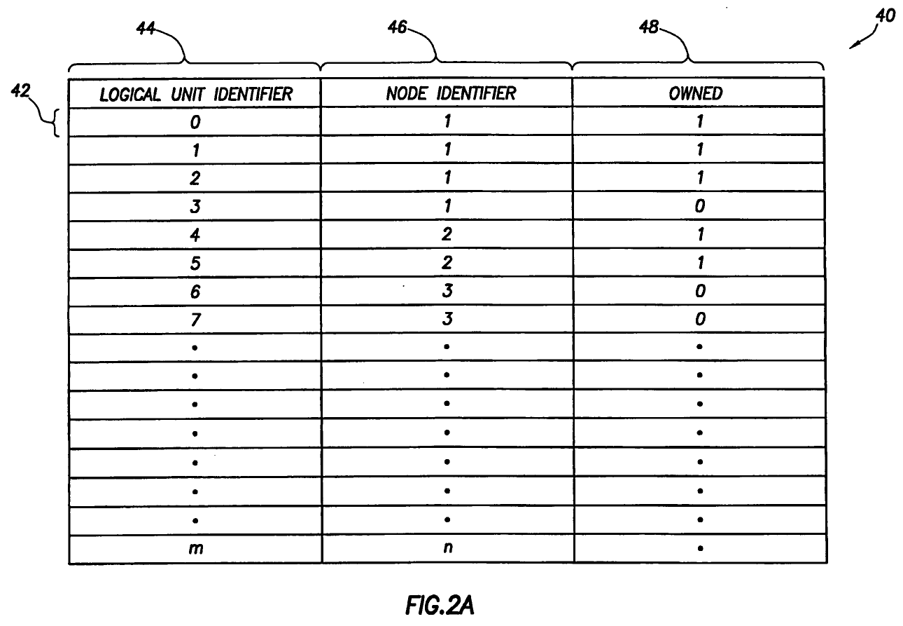

As indicated in FIG. 2A, arbiter 20 maintains a logical unit ownership table that identifies, for each logical unit, the node that owns or last owned the logical unit. An example of the arbiter table 40 is shown in FIG. 2A. Arbiter table 40 includes a logical unit column 44, a node column 46, and an ownership column 48. Logical unit column 44 identifies by a unique number or a code each logical unit of the storage enclosure. Each logical unit of the storage enclosure has a unique row 42 in table 40. In the example of FIG. 2A, there are m nodes in the storage enclosure and m rows in the table. Node identifier column 46 identifies by number each node of the storage network. Ownership column 48 identifies the ownership condition of the logical unit. A 1 is indicated in the ownership column of a row when node of the node column owns the logical unit of the logical unit column. With respect to logical unit 0, the owned column is a 0, indicating that node 1 owns logical unit 0. A 0 is indicated in the owned column when the identified node has released ownership of the logical unit. As an example, a 0 is in the owned column for logical unit 3, which indicates that node 1 once owned logical unit 3 but has since released ownership of logical unit 3, thereby allowing another node of the storage network to assert ownership over logical unit 3. Table entries below the row for node 7 are shown with dashes as entries to indicate that additional rows of data, up to and including row m, may be included in the table.

Shown in FIG. 2B is a diagram that illustrates the organization of the logical units by ownership node. With respect to the ownership data of the table of FIG. 2A, logical units 0-2 are owned by node 1, as indicated by the box surrounding these nodes in FIG. 2B. The dashed lines around logical unit 3 indicate that logical unit 3 was previously owned and subsequently released by node 1. Likewise, the dashed box around logical units 6 and 7 indicate that these logical units were previously owned and subsequently released by node 3. Logical units 4 and 5 are depicted in FIGS. 2A and 2B as being presently owned by node 2.

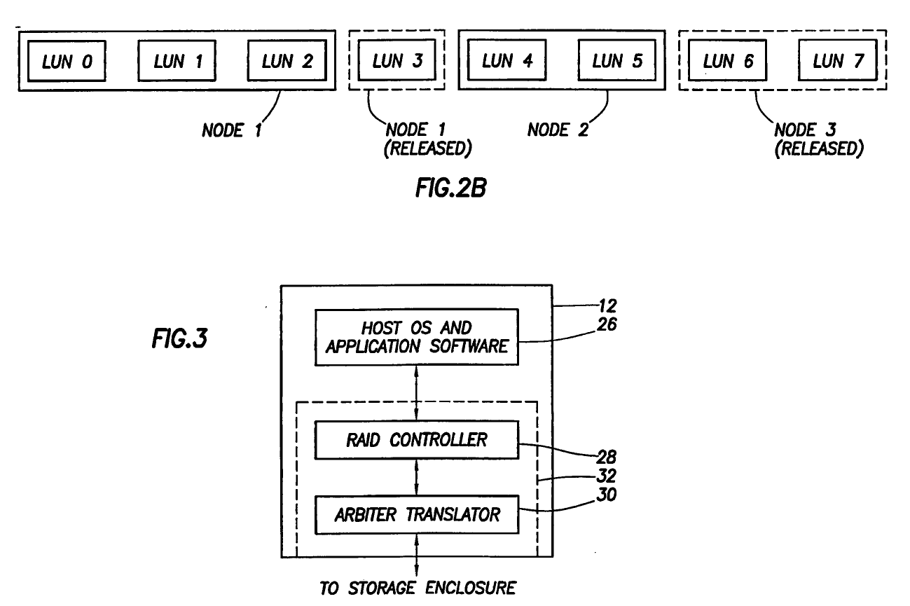

A diagram of each node 12 of the storage network is shown in FIG. 3. Each node includes a set of operating system software and application software 26. Node 12 includes an internal RAID controller 28, which receives data access requests from the software of the node. Coupled to RAID controller 28 is an arbiter translator 30. RAID controller 28 and arbiter translator 30 comprise the RAID layer of node 12. Arbiter translator 30 receives a set of SCSI commands issued by the RAID controller. Arbiter translator 30 translates these commands for transmission to the arbiter 20 of the storage enclosure. As an example a SCSI RESERVE command is translated and submitted to arbiter 20 as a Set Reservation State command, and a SCSI RELEASE command is translated and submitted to arbiter 20 as a Clear Reservation State command. The SCSI RESERVE and the Set Reservation State command attempt to reserve a logical unit for use with the node that issued the command. The SCSI RELEASE and Clear Reservation State command release ownership of a logical unit owned by the node.

When the expander port of the SAS expander of the storage enclosure receives a Set Reservation State command, the arbiter first determines if the owned flag for the requested logical unit is set to indicate that the logical unit is owned by another node of the storage network. If the owned flag of the requested logical unit is set to indicate that the logical unit is owned by another node of the computer network, an error or state message is returned to the requesting node to indicate that the ownership condition of the requested logical unit could not be changed. If the owned flag is not set for the requested node, the ownership of the requested logical unit is assigned to the requesting node. The node column and the owned column of the logical unit of the row of the logical unit ownership table corresponding to the requested logical unit are updated to reflect the assignment of the logical unit to the requested node. A confirmation is transmitted to requesting node to confirm the assignment of the requested logical unit to the requesting node. When the arbiter receives a Clear Reservation State command from a node, the arbiter clears the owned flag for the logical unit that is the subject of the command and updates the logical unit ownership table to reflect the ownership state of the affected logical unit.

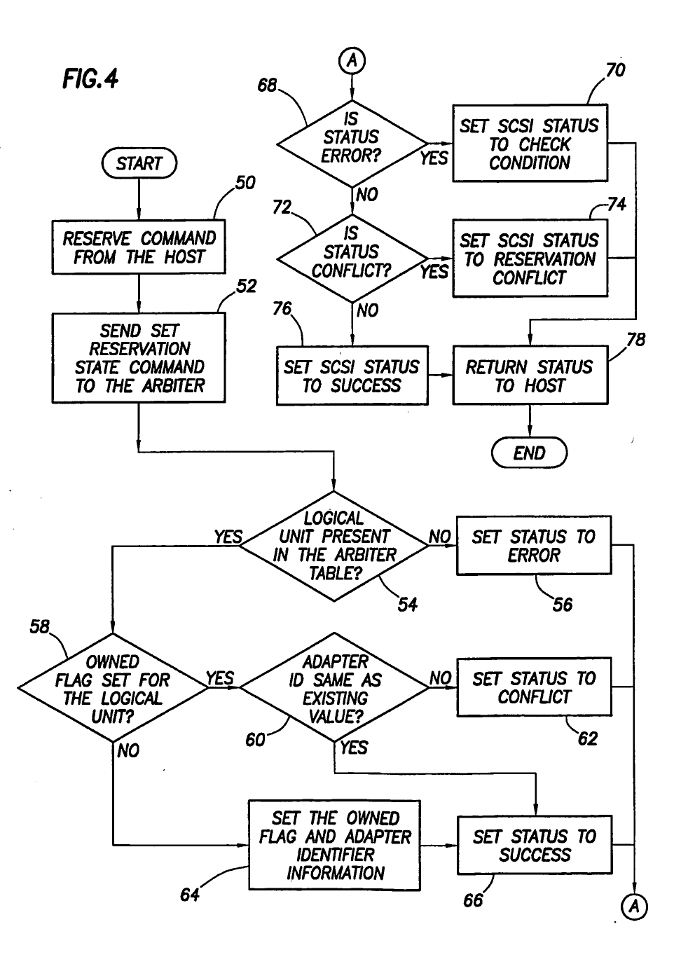

In operation, arbiter 20 receives reservation and release commands from each of the nodes of the storage network. On the basis of these commands, arbiter 20 establishes and releases ownership the logical units of the storage enclosure among the nodes of the storage network. Shown in FIG. 4 is a flow diagram of a method for handling a SCSI RESERVE command issued by a node of the computer network. At step 50, the node issues the SCSI RESERVE command, and, at step 52, the SCSI RESERVE command is translated by the arbiter translator to a Set Reservation State command and the Set Reservation State command is submitted to the arbiter of the SAS expander. After the Set Reservation State command is received by the arbiter, it is determined at step 54 if the logical unit of the command is present in the table. If the node has requested ownership of a logical unit that is not present in the logical unit ownership table, and therefore not present in the storage enclosure of the arbiter, an error status is set at step 56 and the flow diagram continues at point A. If the logical unit is present in the logical unit ownership table, it is determined at step 58 if the owned flag is set for the logical unit that is the subject of the Set Reservation State command. If the owned flag is set, it is next determined at step 60 if the node identified in the table is the same as the requesting node. If the requesting node and the node identified in the table are the same node, thereby indicating that the requesting node already owns the logical unit, a success status is set at step 66 and the flow diagram continues at point A. If it is determined at step 60 that the node identified as owning the logical unit in the table and the requesting node are not the same node, a status indicator is set to the conflict condition to reflect that the requested logical unit is already owned by another node of the storage network. Returning to step 58, if the owned flag is not set for the requested logical unit, the requested logical unit is assigned to the requesting node at step 64 and the table is updated to reflect the requesting node's ownership of the logical unit. Following step 64, a success status is set at step 66.

Following the completion of the Set Reservation State command at the SAS expander, a status indicator is returned to the requesting node. At the arbiter translator of the requesting node, it is determined at step 68 if the status indicator has been set to error, which would indicate that the logical unit that was the subject of the RESERVE command is not present in the storage enclosure. If the status indicator has been set to Error, the status CHECK CONDITION is returned to the RAID controller of the node at step 70 and control of subsequent command issuance is returned to the RAID controller of the node at step 78. If the status indicator is not set to error, it is determined at step 72 if the status indicator is set to Conflict, which would indicate that the requested logical unit is owned by another node of the storage network. If the status indicator is set to Conflict, the status RESERVATION CONFLICT is returned to the RAID controller of the node at step 74 and control of subsequent command issuance is returned to the RAID controller of the node at step 78. Returning to step 72, if the status indicator is not set to Conflict, the status Success is returned to the RAID controller as confirmation that the requested logical unit was assigned to the node. Control of subsequent command issuance is returned to the RAID controller at step 78.

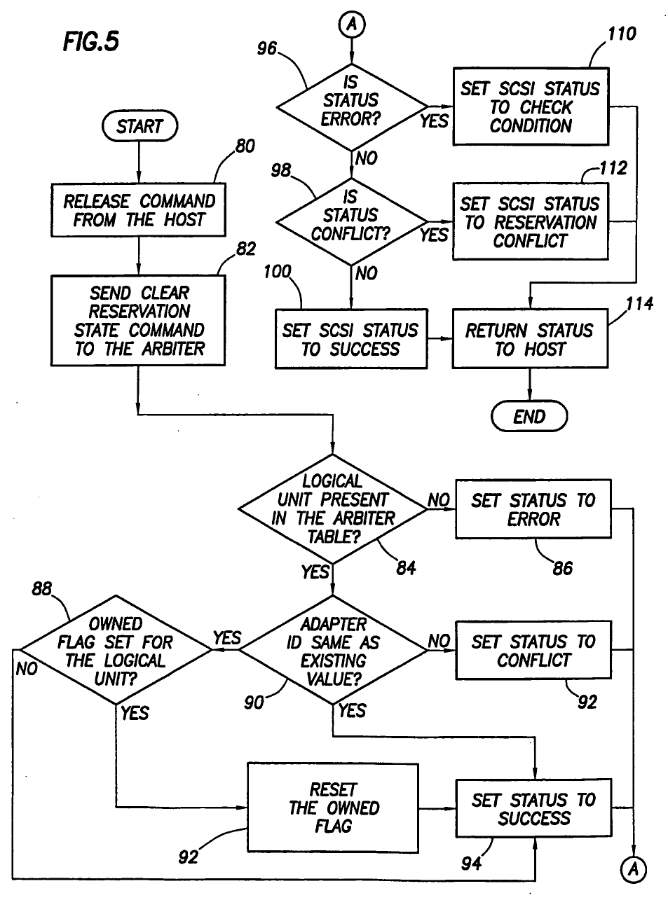

Shown in FIG. 5 is a flow diagram of a method for handling a SCSI RELEASE command issued by a node of the computer network. At step 50, the node issues a SCSI RELEASE command, and, at step 82, the SCSI RELEASE command is translated by the arbiter translator to a Clear Reservation State command and the Clear Reservation State command is submitted to the arbiter of the SAS expander. After the Clear Reservation State command is received by the arbiter, it is determined at step 84 if the logical unit of the command is present in the table. If the node that is the subject of the Clear Reservation State command is a logical unit that is not present in the logical unit ownership table, and therefore not present in the storage enclosure of the arbiter, an error status is set at step 86 and the flow diagram continues at point A. If the logical unit is present in the logical unit ownership table, it is next determined at step 90 if the requesting node is the current owner of the logical unit. If the requesting node is not the current owner of the logical unit, thereby indicating that another node is the owner of the logical unit, a status indicator is set to a conflict condition at step 92 and the flow diagram continues at point A.

With respect to the determination of step 90, the requesting node is the owner of the logical unit if the logical ownership table associates the logical unit with the node, regardless of whether the owned column for the node is indicated as being a 1 (current ownership) or 0 (previous ownership). If it is determined at step 90 that the requesting node is the owner of the logical unit, it is next determined at step 88 if the owned flag is set for the logical unit. If the owned flag is set for the logical unit, the owned flag is reset to a 0 (previous ownership) state at step 92 and a status indicator is set to a success condition at step 94. Following step 94, the flow diagram continues at point A. If the owned flag is not set for the logical unit, indicating that the owned flag is already set to 0, a status indicator is set to a success condition at step 94 and the flow diagram continues at point A.

Following the completion of the Clear Reservation State command at the SAS expander, a status indicator is returned to the requesting node. At the arbiter translator of the requesting node, it is determined at step 96 if the status indicator has been set to error, which would indicate that the logical unit that was the subject of the SCSI RELEASE command is not present in the storage enclosure. If the status indicator has been set to Error, the status CHECK CONDITION is returned to the RAID controller of the node at step 110 and control of subsequent command issuance is returned to the RAID controller of the node at step 114. If the status indicator is not set to error, it is determined at step 98 if the status indicator is set to Conflict, which would indicate that the requested logical unit is not owned by the requesting node. If the status indicator is set to Conflict, the status RESERVATION CONFLICT is returned to the RAID controller of the node at step 112 and control of subsequent command issuance is returned to the RAID controller of the node at step 114. Returning to step 98, if the status indicator is not set to Conflict, the status Success is returned to the RAID controller as confirmation that the requested logical unit was assigned to the node. Control of subsequent command issuance is returned to the RAID controller at step 114.

Other SCSI commands issued by a RAID controller of a node are likewise translated by arbiter translation for handling at the arbiter of the SAS expander. The SCSI command Logical Unit Reset is translated by the arbiter translator as the Reset Reservation State command, which is a command that may be issued by any node of the storage network and results in the resetting of the owned flag for the logical unit that is the subject of the command. In addition, the SCSI command Hard Reset command is implemented through a Reset All command that clears all owned flags and therefore the ownership status of each logical unit of the storage enclosure. Typically, the issuer of a Logical Unit Reset or a Reset All command must have administrative level authority to issue either command.

The system and method disclosed herein provides a technique for managing the ownership of SAS drives in a multiple node cluster network. The placement of an arbiter within or adjacent to the SAS expander of the enclosure provides a module for resolving ownership contentions for the drives of the storage enclosure without requiring the of an external RAID controller. As a result, each node can include an internal RAID controller and rely on the arbiter of the storage enclosure for resolving ownership of the logical units of the storage enclosure among the nodes of the cluster network. The use of an arbiter in the storage enclosure is transparent to each node, as each node may assume that the cluster network includes an external RAID controller that distributes ownership over the drives of the storage enclosure. The arbiter need not be included as a separate module within the storage enclosure. The functionality of the arbiter could be included as part of the software-driven functionality of the processor of the storage enclosure or the SAS expander.

The system and method disclosed herein is not limited in its application to a storage network that includes a RAID controller that reserves access to storage resources according to a set of SCSI RESERVE and RELEASE commands. Rather, the system and method disclosed herein can be implemented in any network to provide a virtual external controller for managing the ownership of storage resources of the network. The arbiter of the storage enclosure that is described herein can manage the resources requests of server nodes regardless of the access protocols being used by the server nodes. As such, arbiter of the storage enclosure disclosed herein can server as a virtual external storage controller irrespective of the access protocol used by the server nodes of the network.

Although the present disclosure has been described in detail, it should be understood that various changes, substitutions, and alterations can be made hereto without departing from the spirit and the scope of the invention as defined by the appended claims.

What is claimed is:

1. A cluster network, comprising:
a plurality of nodes, wherein each node includes a storage controller operable to transmit data access commands to a storage enclosure of the cluster network, and wherein each node is operable to initiate ownership commands concerning the ownership of the storage drives of the storage enclosure; and
a storage enclosure, comprising:
a plurality of storage drives; and
an arbiter operable to set the ownership status of each of the storage drives by the nodes on the basis of ownership commands initiated at each of the nodes of the cluster network.

2. The cluster network of claim 1, wherein the storage controller of each node is a RAID controller and wherein the storage drives of the storage enclosure are managed according to RAID storage methodology.

3. The cluster network of claim 1, wherein the nodes and the storage enclosure of the cluster network communicate according to a Serial Attached SCSI communications protocol.

4. The cluster network of claim 3, wherein the storage enclosure of the cluster network further comprises an SAS expander coupled to each of the storage drives and operable to communicate data access requests received by the storage enclosure according to the ownership status of the storage drives.

5. The cluster network of claim 1, wherein the arbiter comprises a processor associated with an expander in the storage enclosure.

6. The cluster network of claim 5, wherein the arbiter comprises a processor associated with a virtual or physical phy of an expander in the storage enclosure.

7. The cluster network of claim 8, wherein the arbiter is operable to access a table that identifies, for each storage drive of the storage enclosure, whether each respective storage drive is owned by a node of the cluster network.

8. The cluster network of claim 7, wherein the table identifies, for each storage drive owned by a node, the identity of the node that owns the storage drive.

9. The cluster network of claim 1, wherein the arbiter is operable, in response to ownership commands initiated at a node, to establish ownership of a node over a set of storage drives within the storage enclosure and wherein the set of storage drives is managed according to a fault tolerant storage methodology.

10. A storage enclosure, comprising:
an input port operable to receive communications from a plurality of nodes of a computer network;
an arbiter coupled to the input port of the storage enclosure;
an expander coupled to the input port; and
a set of storage drives;
wherein the arbiter establishes the ownership condition of each of the storage drives on the basis of ownership commands received from the nodes of the computer network.

11. The storage enclosure of claim 10, wherein the storage drives may be grouped into ownership sets owned by a single node of the computer network such that the group of storage drives may be managed according to a RAID storage methodology.

12. The storage enclosure of claim 10,
wherein the expander is operable to route communications to the storage drives according to an Serial Attached SCSI communications protocol; and
wherein each of the drives of the storage enclosure is a Serial Attached SCSI storage drive.

13. The storage enclosure of claim 10, wherein the arbiter comprises a processor associated with the storage enclosure.

14. A method for managing the ownership of logical units within the storage enclosure of a storage network, comprising:
initiating a logical unit ownership commands at a node of the storage network;
receiving the logical unit ownership command at an arbiter associated with a storage enclosure of the storage network, wherein the logical unit ownership command initiated at the node is a SCSI command and wherein the command received at the arbiter is translated for execution by the arbiter;
accessing a table reflecting the ownership status of the logical units of the storage enclosure;
executing the logical unit ownership command at the arbiter on the basis of the content of the table;
transmitting to the node issuing the command a communication concerning the result of the initiated logical unit ownership command.

15. The method for managing the ownership of logical units within the storage enclosure of a storage network of claim 14, further comprising the step of controlling the routing of communications to logical units of the storage enclosure on the basis of the ownership status of each of the logical units of the storage enclosure.

16. The method for managing the ownership of logical units within the storage enclosure of a storage network of claim 15,
wherein each of the logical units of the storage enclosures comprises a Serial Attached SCSI drive; and
wherein the step of controlling the routing of communications to logical units comprises the step of controlling the operation of a Serial Attached SCSI expander coupled to each of the logical units.

17. The method for managing the ownership of logical units within the storage enclosure of a storage network of claim 14, wherein the steps of accessing a table and executing the logical unit ownership command are performed by a processor associated with the storage enclosure.

18. A method for handling ownership requests for logical units of a cluster network, comprising:
initiating an ownership command at a first server node of the cluster network to establish ownership of the first server node over a logical unit of the cluster network, wherein the ownership command is initiated according to a SCSI command protocol;
translating the ownership command to a command recognizable by an arbiter associated with the logical units of the cluster network;
receiving the translated ownership command at the arbiter;
determining if the logical unit that is the subject of the ownership command is owned by another node of the cluster network; and
assigning ownership of the logical unit that is the subject of the ownership command to the first server node if it is determined that the logical unit is not owned by another node of the cluster network.

19. The method for handling ownership requests for logical units of a cluster network of claim 18, further comprising the step of transmitting a confirmation to the first node to indicate whether the ownership command was successfully completed.

20. A method for handling ownership requests for logical units of a cluster network, comprising:
initiating an ownership command at a first server node of the cluster network to release ownership of a logical unit from a first server node of the cluster network, wherein the ownership command is initiated according to a SCSI command protocol;
translating the ownership command to a command recognizable by an arbiter associated with the logical units of the cluster network;
receiving the translated ownership command at the arbiter;
determining if the logical unit that is the subject of the ownership command is owned by another node of the cluster network; and
resetting the ownership status of the logical unit to indicate that the cluster unit is not owned if it is determined that the logical unit is not owned by another server node of the cluster network.

21. The method for handling ownership requests for logical units of a cluster network of claim 20, further comprising the step of transmitting a confirmation to the first node to indicate whether the ownership command was successfully completed.
